(19) United States
(12) Patent Application Publication
(10) Pub. No.: US 2011/0129296 A1
(43) Pub. Date: Jun. 2, 2011

(54) Aggregate pre-heating systemsand method

(76) Inventor: Wesley Van Velsor, Charlestown, NH (US)

(21) Appl. No.: 12/924,103

(22) Filed: Sep. 21, 2010

Related U.S. Application Data
(63) Continuation-in-part of application No. 11/805,021, filed on May 22, 2007, now abandoned.
(60) Provisional application No. 60/802,360, filed on May 22, 2006.

(51) Int. Cl. E01C 23/14; B28C 5/34; B02C 11/08; E01C 7/00; E01C 21/00; E01C 23/12

(52) U.S. Cl. 404/79; 366/24; 241/65

(57) ABSTRACT

A portable system for heating aggregate material, especially reclaimed asphalt pavement (RAP), a portable system for producing asphalt, a portable system for continuously repaving roadway, and a method for continuously repaving roadway. Each system includes a conveyor belt, at least one infrared chamber disposed in substantially parallel relation to the conveyor belt at a distance sufficient to allow infrared heating of the aggregate material, a source of fuel, a fuel control in communication with the infrared chamber, and at least one mixer disposed between the infrared chamber and the conveyor belt and dimensioned and disposed relative to the conveyor belt so as to mix the aggregate material during heating and drying.

### CLAIM OF PRIORITY

This application is a continuation in part of co-pending U.S. Non-Provisional patent application Ser. No. 11/805,021, filed on May 22, 2007, and claims the benefit of priority of U.S. Provisional Patent Application Ser. No. 60/802,360, filed on May 22, 2006.

### FIELD OF THE INVENTION

The present invention relates to the field of asphalt manufacturing and, in particular, to a portable reclaimed asphalt pavement (RAP) pre-heating system for pre-heating RAP being conveyed into asphalt manufacturing modules during the asphalt manufacturing process.

### BACKGROUND OF THE INVENTION

The creation and maintenance of millions of miles of roads depend on asphalt production. Most asphalt production is performed in asphalt plants or factories from whence the asphalt is transported to the pavement site. In many cases, this involves significant distances, while transporting heavy materials, such as silos to store the asphalt and the asphalt itself. Especially for longer distances or in colder climates, there is also a need to keep the asphalt warm enough, and therefore soft enough, to be compacted into the road during paving. The distances traveled, combined with transporting heavy materials, and the need to heat the asphalt during transport, together require a great deal of fuel, which increases the cost and carbon footprint of the operation. Therefore, there is a need for portable asphalt manufacture. As a part of a portable asphalt plant, there is a need to be able to dry aggregate material outside of a factory. In particular, there is a need to safely dry reclaimed or recycled asphalt pavement (“RAP”).

The raw material for roadway asphalt, known in the industry as Hot Mix Asphalt (“HMA”), is usually prepared at a batch plant. In addition to the asphalt oil itself, HMA includes an aggregate, which is typically a mixture of sand, small rocks, and other filler material, such as shredded rubber tires, or may be RAP that is crushed into small pieces. This aggregate used in the manufacturing process invariably has moisture entrapped therein, which must be removed before the asphalt oil is added.

Conventional HMA plants include a conveyor belt upon which aggregate is conveyed into a rotating drying drum, which may include impellers to lift the aggregate to assist in the drying process. The drum is typically rotated and heated to a very high temperature. Heating is typically accomplished by firing an oil burner and using a fan located adjacent to the drum to direct a flow of hot air into the drum. The aggregate is tumbled in the hot air flow by the rotation of the drum, and by the impellers lifting the aggregate and dropping it into the air stream, essentially drying and heating the aggregate. Once the aggregate is heated to a desired temperature, typically in the range of 120-180° C., the aggregate is sufficiently dried and a flow of hot liquid asphalt is introduced to the aggregate, and mixed therewith, producing the finished HMA.

In today's industry, there is great emphasis on using RAP. It reuses existing materials, rather than requiring the quarrying of new aggregate materials. It also has the advantage of already having some asphalt content, thus lowering the amount of asphalt needed to make a new finished product. In these respects, it is both economical and green. Using RAP presents challenges not present with traditional asphalt production, however. Specifically, although the RAP must be heated to at least 212° F. for the moisture to be released from the aggregate, as RAP contains asphalt, it can only be heated to a certain extent before the asphalt ignites around 375-400° F. As traditional asphalt production generally involves aggregate materials such as rock and sand, before the asphalt is introduced to the mix, there was not such a need for temperature control. Demand for asphalt that is 25-50% RAP is common now, but given the challenges inherent in using RAP, it is difficult to raise the percentage above 15%. As demand for, and interest in, RAP grow, production systems with better heat control are necessary.

The process employed by conventional HMA plants is effective at drying and heating the aggregate and generally produces an acceptable end product. However, this process has three substantial drawbacks.

First, the burners used to heat the aggregate during the drying and pre-heating process use an enormous amount of fuel, which is costly both in terms of purchasing the oil and in terms of controlling the emissions produced thereby. Therefore, the longer these burners are forced to run, the greater the expense of producing the HMA. Unfortunately, even with the use of impellers to mix the aggregate during drying, bulk drying of the entire batch of aggregate at one time is inefficient and results in the burners being fired for a significant period of time to effect drying, resulting in a significant amount of expensive fuel being used.

Second, the longer the drying process takes, the fewer batches of HMA that may be produced. Because the equipment used in HMA production is very expensive, and because the demand for HMA is such that all batches produced by a given plant would be readily sold, increasing the rate at which batches of HMA may be processed will greatly increase the profits for HMA manufacturers.

Third, the amount of aggregate used in each batch produced by the HMA manufacturing process is typically measured by the weight of the aggregate in the drying drum. Therefore, variations in the moisture content of the aggregate can cause the amount of aggregate to be too low. Thus, the manufacturer is forced to either live with these variations, resulting in batch-to-batch inconsistencies of the HMA produced, or to add more wet aggregate to the drum, which further increases the amount of fuel used and drying time.

In addition to HMA, a number of companies have recently developed formulations for Warm Mix Asphalt (WMA) to replace traditional HMA. WMA is manufactured using a process similar to HMA, but uses different formulations of aggregate and asphalt additives that are each mixed at lower temperatures than HMA. Switching from HMA to WMA reduces the amount of fuel used in the manufacturing process, as it is heated to lower temperatures than HMA, and allows the use of certain additives that cannot withstand the temperatures required during the production of HMA. Further, WMA has been found to reduce the curing time of the asphalt, allowing a shorter period of time between laying the asphalt surface and allowing the pavement to be used.

A number of tests on WMA have produced encouraging results. However, a recent report by the National Center for Asphalt Technology cautioned that the moisture content of the mix is an important consideration and cites the potential for moisture damage due to too much water left in close content with the aggregate. Thus, there is a need for a means for pre-drying the aggregate used in WMA production in order to reduce the chance of moisture damage.

At least two systems currently exist for drying particulate matter, such as aggregate, using a heating element over a conveyor belt. The first system is disclosed in U.S. Pat. No. 4,136,964 to Swisher. This is an apparatus for simultaneously mixing and conveying particulate material, the apparatus comprising a housing having an input end and an output end disposed vertically higher than the input end, means for feeding the particulate material into the input end of the housing, a conveyor disposed within the housing and having a plurality of lifting surfaces provided with perforations therethrough so that a portion of the particulate material being lifted by each lifting surface descends through the perforations and is mixed with particulate material being lifted by lifting surfaces disposed therebelow, and, means for discharging the mixed particulate material from the output end of the housing.

The housing of the mixer/conveyor is provided with at least one opening through the upper wall section thereof to facilitate the introduction of heated exhaust gases produced by an associated burner assembly connected thereto. Each burner assembly is comprised of a housing having suitable refractory material lining the inner surfaces thereof, and an oil or gas fired burner of the conventional construction. Hydrocarbon fuel for the burner will be supplied in a conventional manner from a suitable source of fuel, while combustion-supporting air is preferably supplied by a blower assembly via an air duct. An adjustable draft, exhaust damper assembly should also be connected to the output end of the housing to facilitate control of the pressure in the mixer/conveyor as well as to direct the heated exhaust gases exiting from the housing.

Although capable of drying particulate matter, this system, and its burner assembly in particular, is ill suited for portability. First, the mixer/conveyor and burner assembly are bulky because they are completely enclosed so that the heated exhaust gases may flow across the material to be dried. This bulk cannot be diminished to provide better portability without thwarting the burner assembly's heating capabilities. Moreover, doing so, especially in the field, would cause the introduction of the exhaust gases into the atmosphere. Second, in part because of the system's bulk, it is difficult to set up and break down, which is a key aspect of portability. Given the size and weight of the various assemblies that make up the system, a crane is necessary to position the assemblies. A crane is another large vehicle, requiring a skilled operator, which would have to come out to the site, greatly increasing the cost and carbon emissions of using the system.

The second currently existing system for drying particulate matter, such as aggregate, using a heating element over a conveyor belt is disclosed in U.S. Pat. No. 5,557,858 to Macaluso et al. This system is an infrared wood product dryer apparatus including an enclosure structure defining an interior, a conveyor assembly configured for conveying a particulate material along a material flow path through the interior substantially between an inlet and an outlet, an array of infrared radiant energy sources configured for exposing the material to infrared radiant energy while it is conveyed along the path, and a series of agitators configured for agitating the material in order to increase the exposure of the material to the infrared radiant energy. A gas recirculation assembly is provided to direct a heated interior gas onto the material in order to convection-dry the material. An exhaust assembly reduces the moisture content of the interior gas by drawing a quantity of the gas from the dryer so that fresh gas having a lower moisture content may be drawn into the dryer.

This system is also capable of drying particulate matter, but is also ill suited for portability. First, as a practical matter, the inlet to which material to be dried is introduced to the system is at the top of the system, so that material must be lifted up to be dried. This lifting up will likely require an added mechanical element, for the system to be used in the field. The more elements necessary for the system's use, the more costly and difficult it becomes to use in the field. Moreover, portable systems need to be able to be driven around on a truck or other vehicle, and this system is too tall for that type of transportation. Any system that is going to be driven on roads needs to be fairly flat so that trucks can get through tunnels and other low passages while hauling the system. This system has at least three stacked layers of conveyor belts and heaters within the enclosure structure, making it quite tall, and thus unwieldy for road transportation.

Therefore, there is a need for a portable system and method for reducing the amount of fuel consumed to dry and pre-heat the aggregate used in the asphalt manufacturing process, for reducing the amount of time that it takes to dry and pre-heat the aggregate used in the asphalt manufacturing process, to increase the accuracy of the amount of aggregate used in the asphalt manufacturing process in order to increase the batch-to-batch consistency of the asphalt produced thereby without the need to add wet aggregate to the batch during drying and pre-heating, and to reduce the risk of moisture damage due to the presence of excess moisture in aggregate used in the production of WMA.

### SUMMARY OF THE INVENTION

The present invention is a portable system for heating aggregate material, a portable system for producing asphalt, a portable system for continuously repaving roadways, and a method for continuously repaving roadways. In its most basic form, the system for heating aggregate material includes a trailer sized and dimensioned to hold an assembly including a conveyor belt in communication with a source of the aggregate material, at least one infrared chamber, a source of fuel, and at least one mixer disposed between the infrared chamber and the conveyor belt. The conveyor belt is preferably manufactured of a rubberized material that is adapted to convey the aggregate material at a predetermined rate. The infrared chamber, or chambers, is disposed in substantially parallel relation to the conveyor belt at a distance sufficient to allow infrared heating of the aggregate material. The fuel source is preferably a gaseous fuel, such as propane, that is in communication with the infrared chamber. The mixer is dimensioned and disposed relative to the conveyor belt so as to mix the aggregate material during pre-drying.

This system is particularly well suited for partial repaves. Center line cracks in a paved roadway are common and occur more frequently than cracks in the rest of the road. Outer edges of roads that have been widened similarly usually fail long before the original roadway fails. A partial repave could repave only a center line crack and/or damaged outer edges that need repair more frequently than the entirety of the road needs repaving. Such partial repaves save the time and expense of a full repave when the remainder of the road is in good shape. The system is well suited for repaving of areas only 1-2 feet wide, as would be the situation with the repave of only a center line and/or outer edges of a roadway.

In operation, the conveyor belt conveys the aggregate material from its source and under the infrared chamber at a predetermined rate to a terminal end of the conveyor belt. The aggregate is preferably partially or entirely made up of RAP. The fuel flows to the infrared chamber, which burns the fuel causing the infrared chamber to emit infrared radiation therefrom. The infrared radiation contacts the top surface of the aggregate that is conveyed on the conveyor belt and acts to heat the top portion of the aggregate material proximate to the infrared chamber. The mixer then mixes the aggregate material such that heated and unheated aggregate material are mixed together, allowing the unheated aggregate material proximate to the conveyor belt to rise to the top surface proximate to the infrared chamber. The infrared radiation from the infrared chamber then heats the mixed aggregate material to effectively pre-heat and pre-dry the aggregate material.

The preferred heating system includes at least three, and preferably eight infrared chambers. The preferred infrared chambers include a solid aluminum top cover. Moisture escapes out of the upper end of the infrared chambers in the gaps between the chambers where the mixers are placed, as discussed below. The conveyor belt is preferably inclined so as to act as a chimney. In an alternative embodiment, the top portion of the infrared chamber is manufactured of expanded metal, which allows for the escape of such moisture. In still other embodiments, the chamber includes a plurality of holes formed therethrough to allow such moisture to be vented. Each infrared chamber includes a plurality of infrared converters.

The preferred heating system also includes at least one igniter assembly in communication with the infrared chamber. The igniter assembly is adapted to ignite the fuel within the infrared chamber so that it may be burned and turned into infrared radiation. The preferred embodiment utilizes multiple, individual igniter assemblies, which are each in communication with a single infrared chamber and are independently controlled by the control box. Each igniter assembly is itself in communication with the source of fuel, and includes two igniter rods, two sparker transformers with mounting plates, one flame sensor, a main gas valve, and a pressure switch. The rods are in communication with the infrared converters of the infrared chamber, so that the ignited fuel may travel into the converters. Having individual igniter assemblies for each infrared chamber, rather than a single igniter used to ignite the fuel within each of the chambers, is preferable as it allows individual infrared heaters to be turned off. This provides greater control over the heating of the system, which is particularly important when RAP is being used as the aggregate.

The mixers are placed between the infrared chambers so as to mix the aggregate material as it travels along the conveyor belt. The infrared chambers are preferably disposed in a row over the conveyor belt such that each infrared chamber is disposed relative to an adjacent infrared chamber so as to form a gap therebetween. One mixer is preferably disposed within each gap. One mixer is also preferably disposed at the end of the conveyor belt, after the last infrared chamber.

In the preferred embodiment for use with RAP, the mixer is a rotary mixer assembly. This preferred mixer is a bolted roller with 5″ diameter disposed across the conveyor belt. The roller includes six evenly spaced bolts protruding from cross sections spaced 2″ apart down the length of the pipe, with every other set of bolts being offset from the sets of bolts on either side of it. In the preferred embodiment, the mixers are individually controlled as to how fast they rotate, and thus mix the aggregate.

In another embodiment, the mixer is a series of ramps that are disposed proximate to the conveyor belt. Each ramp has a ramp surface that is disposed at an angle from the plane formed by the conveyor belt and is dimensioned to allow the asphalt aggregate to be pushed up the ramp by aggregate that is in contact with the conveyor belt and to tumble back onto the belt, effectively mixing the aggregate. This embodiment is not preferred because the preferred incline of the conveyor belt leads to damming of the aggregate material at the mixers.

In another embodiment, the mixing is a result of multiple conveyor belts that are spaced to allow the aggregate material to tumble from one conveyor belt to the adjacent conveyor belt. Once tumbled, the aggregate material is further mixed by moving through the tines of a mixer as described below. This embodiment is not preferred as the multiple conveyor belts, each with separate mechanics, drive up the cost of the system.

In some embodiments, the mixers include a plurality of tines forming a plurality of spaces therebetween, and each is dimensioned and disposed within each gap such that each tine of one mixer is aligned with a space of adjacent mixers. In this manner, the aggregate is thoroughly mixed rather than just having the areas adjacent to the tines mixed. This embodiment is not preferred for use with RAP because it has been found that it does not release moisture from the aggregate as well as the mixers mentioned above.

In other embodiments, the mixer includes a channel, and a plurality of tines rotatably attached to the channel. The tines are in communication with at least one spring and are disposed in sufficiently close proximity to the conveyor belt so as to contact the aggregate material conveyed by the conveyor belt. The spring allows the tines to flex while preventing them from becoming entangled with the conveyor belt. In this embodiment, the tines may be joined together into a rake and a single spring is used to maintain the tines in position. However, in other embodiments, each tine is independent from the other tines and is in communication with its own spring. These embodiments are also not preferred for being less efficient at moisture release.

In the preferred embodiment, an area at the end of the conveyor belt includes multiple smaller mixers disposed between the conveyor belt and the infrared chambers. This area is preferably the length of two infrared converters down the conveyor belt, but be less or more area of the conveyor belt. The small mixers are preferably similar to the preferred bolted rollers discussed above, but smaller in diameter and the length of the protruding bolts. These small mixers may be directly adjacent to one another, rather than distanced by the length of an infrared chamber. They may also be periodically spaced between the larger mixers that are spaced between each infrared chamber. The speed at which the small mixers rotate is also preferably controllable, and is preferably faster than the speed of rotation of the large mixers. These mixers protect against ignition of the asphalt within the RAP by ensuring even distribution of heat throughout the aggregate when the aggregate is at its hottest at the end of the conveyor belt.

The preferred embodiment includes further heat control measures to safeguard against asphalt ignition. Specifically, the second to last space above the conveyor belt for an infrared chamber is preferably occupied not by an infrared chamber, but by a heat reflector that will reflect back the heat of the aggregate, but not introduce additional heat. There is also preferably a thermometer or other heat sensor between the heat reflector and the last infrared chamber that indicates the temperature of the aggregate at that point. The last infrared chamber will be activated if the aggregate is not near temperatures at which the asphalt is likely to ignite. Alternatively, it will remain dormant, without adding additional heat to the aggregate if the aggregate is near temperatures at which the asphalt is likely to ignite. Although this is the preferred embodiment, it is understood that all spaces may be filled with infrared chambers, and that heat reflectors may be substituted for one or more heat chambers in any of the positions along the conveyor belt. Finally, at least the last infrared chamber at the end of and above the conveyor belt, but preferably all infrared chambers above the length of the conveyor belt are adapted to move up and down to increase or decrease the distance between the infrared chambers and the conveyor belt. Furthermore, as discussed above, as each infrared chamber includes a designated igniter, it is possible to turn each individual infrared chamber on and off as desired.

Some embodiments of the heating system of the present invention include at least one hygrometer and/or thermometer for determining the moisture content and/or temperature of the aggregate at least at the start of the pre-heating process. In such embodiments, the hygrometers and/or thermometers are preferably in communication with a conveyor control, which slows the conveyor belt or speeds up the conveyor belt based upon the amount of moisture within the aggregate. Thus use of such a control is preferred when the system is used in connection with WMA manufacturing as it allows for careful control of the amount of moisture while maximizing the speed of the process in instances where there are minimal amounts of moisture within the aggregate.

The preferred heating system includes a control box in electrical communication with the infrared chamber and the source of fuel. The control box includes controls for controlling several system functions, including the operation of each individual igniter assembly, the flow of fuel from the source to the infrared chambers, blower motor operation, conveyor belt speed control, large mixer rotation speed controls, small mixer rotation speed controls, and infrared chamber elevation controls.

The preferred heating system also includes at least one blower motor in communication with the control box, the source of fuel, a source of air, and the infrared chamber. The blower motor is controlled by the control box and is adapted to mix fuel and air together and force the mixture of fuel and air into the infrared chamber. The use of a blower motor is preferred as it allows the infrared chamber to consistently produce a greater amount of heat than may be produced by relying upon the pressure from the source of fuel.

The preferred heating system also includes a source of power, preferably a generator disposed on top of the trailer and capable of powering the controls and mechanical elements of the system.

In its most basic form, the portable system for producing asphalt includes the heating system as described above with a portable asphalt producing module disposed on the trailer at the terminal end of the conveyor belt so that the conveyor belt provides heated and dried aggregate material to the asphalt producing module. The asphalt producing module includes a pugmill and an additive receptacle. The pugmill is preferably portable, and may be substituted in some embodiments with a drum mill. The additive receptacle is a receptacle adjacent to the pugmill that introduces additives into the aggregate material supplied to the pugmill. When employing conventional HMA methods, the additive receptacle adds liquid asphalt to the dried aggregate material to produce asphalt that may pave a road. Alternatively, when employing WMA methods, the requisite additives may be introduced to turn the mix into WMA that may pave the road. The addition of either liquid asphalt for HMA, or additives for WMA is automated. Moreover, the asphalt producing module is preferably adapted for either alternative.

In its most basic form, the system for continuously repaving a roadway includes a joint heater, a grinder, a hopper, a drying apparatus, an asphalt producing module, a paver, and a roller. The joint heater is adapted to heat the road to be ripped up before it is ripped up so as to soften the material, and includes a tractor pulling at least one trailer with infrared heaters attached to the trailer's underside so as to heat the ground beneath the trailer. The grinder is adapted to rip up the pavement and grind it into small pieces of aggregate material. The grinder deposits the ground up aggregate material into the hopper. The hopper is adapted to level out the flow and depth of aggregate material from the grinder. In the preferred embodiment, the hopper has sensors so that it can determine if more aggregate material is required than what the grinder provided in order to keep up the desired production rate of the repaving system. The hopper also has storage capabilities for holding aggregate material not provided by the grinder so that if the sensors determine that more aggregate material is needed, the hopper can add more material. These features are particularly useful when RAP is being used in the repaving process, as additional material may be necessary to sufficiently repave the area from which the RAP has just been ripped from the road. The hopper provides an even layer of aggregate material to the drying apparatus.

The drying apparatus is a portable heating system as described above including the conveyor belt, infrared chambers, source of fuel, and mixers. The drying apparatus heats and dries the aggregate material as it travels along the conveyor belt. At the conveyor belt's terminal end, the dried aggregate material is deposited in an asphalt producing module, also described above.

The repaving system also includes a paver, which can be positioned adjacent to the asphalt producing module so that the asphalt producing module can provide the newly made asphalt directly to the paver. The paver can then lay down the asphalt over the area of road that was just ripped up. The roller may then follow the paver and compact the asphalt. In this way, the road is replaced with new, recycled asphalt at the same rate at which it was ripped up, moments after it was ripped up.

In the preferred repaving system, the system also includes a cleaning unit that leads the repaving system by vacuuming up dirt in the roadway to be repaved before it is preheated by the join heater.

The preferred repaving system also includes at least one ground infrared heater attached to the bottom of the trailer such that it emits heat onto the area of road that has been ripped up by the grinder. Heating the ground to be repaved allows for a better thermal bond between the ground and the asphalt to be replaced upon the ground. The ground infrared heaters raise the temperature of the ground by approximately 80-100° F., and prepare the ground for the hot asphalt to be laid down so as to avoid a cold joint.

In the preferred embodiment of the repaving system, the system includes six vehicles lined up so that they can operate together. The vehicles are, in order, the cleaning unit, the joint heater, the grinder, the trailer holding the hopper, drying apparatus and asphalt production module, the paver, and the roller. The joint heater follows the cleaning unit so that it preheats the roadway just vacuumed by the cleaning unit. The grinder follows the joint heater so that it rips up the roadway just preheated and softened by the joint heater. The trailer follows the grinder and is aligned with the grinder so that the grinder can deposit the aggregate material into the hopper on the trailer at the first end of the conveyor belt of the drying apparatus. The ground infrared heaters attached to the bottom of the trailer thus heat the ground that has just had pavement removed from it. The paver follows the trailer and is aligned with the trailer so that the asphalt producing module can provide the paver with freshly made asphalt, and the paver lays down the asphalt over the area of ground that has just had pavement removed from it. The roller follows the paver so that it compacts the asphalt just laid down by the paver. Some embodiments do not include the cleaning unit. In some embodiments, the drying apparatus and asphalt producing module are disposed on separate vehicles. In all embodiments, however, the vehicles and/or trailers are aligned so as to operate the system as described and continuously repave the roadway.

The preferred method for continuously repaving a road includes the steps of vacuuming the roadway to be ripped up; pre-heating the roadway to be ripped up; ripping up the roadway to be repaved; grinding the cleaned, ripped up roadway into aggregate material; depositing the aggregate material from the grinder to a hopper; depositing the aggregate material from the hopper to a conveyor belt; conveying the aggregate material along the conveyor belt under heating elements; mixing the aggregate material as it is conveyed along the conveyor belt; heating the ground to be repaved; depositing the aggregate material into an asphalt producing module; providing the asphalt product to a paver; laying down asphalt over the roadway that was just ripped up with the asphalt product; and compacting the asphalt product with a roller.

The systems and method of the present invention greatly reduce fuel consumption in asphalt production and road paving. The heating system alone provides dry, warm aggregate material to the asphalt producing module. The fact the aggregate material is already warm means that asphalt producing module need not provide as much heat. In other words, the liquid asphalt being added to the aggregate need not be so hot. The fact that the aggregate material is completely dry ensures consistent high quality of the asphalt produced in the asphalt producing module. The portability of the repaving system means that asphalt can be produced in situ, eliminating or greatly reducing transportation fuel needs. Moreover, as the asphalt can be laid down immediately after it is produced, when it is still warm, fuel is saved from maintaining the heat of the asphalt and/or having to reheat the asphalt between its production and its placement on a road. The portable repaving system is particularly useful for small or remote towns that may be far from a conventional asphalt producing factory.

The system and methods are also very well suited for use with RAP. As described above, several heat controlling measures, such as adjustable elevation of the infrared chambers, individual controls for each infrared chamber, temperature sensors, additional mixers, and the strategic substitution of heat reflectors for infrared chambers in certain places make these systems much safer to use with RAP. As temperature is well controlled, the possibility of igniting the asphalt inherent in the RAP is lessened, if not eliminated. Moreover, the preferred mixer for these systems and the preferred positioning of the conveyor belts at an incline allow for optimal moisture release from the RAP, which commonly has high moisture content at the outset.

Therefore, it is an aspect of the invention to provide a portable aggregate heating system, a portable asphalt producing system, a portable system for continuously repaving a roadway, and a method for continuously repaving a roadway.

It is a further aspect of the invention to provide systems capable of controlling the heat during RAP drying so that the asphalt in RAP does not ignite.

It is a further aspect of the invention to reduce the amount of fuel consumed to dry the aggregate used in the HMA manufacturing process.

It is a further aspect of the invention to provide a system and method for reducing the amount of time that it takes to dry the aggregate used in the HMA manufacturing process.

It is a further aspect of the invention to provide a reflector used in connection with heaters in order to focus the heat downward.

It is a further aspect of the invention to provide a system and method to increase the accuracy of the amount of aggregate used in the HMA manufacturing process in order to increase the batch-to-batch consistency of the HMA produced thereby without the need to add wet aggregate to the batch during drying.

It is a further aspect of the invention to provide a system and method to reduce the risk of moisture damage due to the presence of excess moisture in aggregate used in the production of WMA.

It is a further aspect of the invention to reduce the amount of transportation necessary to provide asphalt to a road needing paving.

It is a further aspect of the invention to reduce the amount of fuel used in rewarming asphalt in preparation for its use in paving.

It is a further aspect of the invention to provide a portable asphalt making system that may be quickly and easily assembled and rearranged as necessary.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a side view of one embodiment of the heating system of the present invention.

FIG. 2 is a side view schematic of one embodiment of the heating system of the present invention without the trailer.

FIG. 3A is a perspective view of the preferred bolted roller mixer of the present invention.

FIG. 3B is a cross section view of the preferred bolted roller mixer of the present invention.

FIG. 4 is a side view of the preferred infrared chamber of the present invention.

FIG. 5 is a top view of the preferred embodiment of the heating system of the present invention.

FIG. 6 is block diagram showing the functions controlled by the preferred control box of the present invention.

FIG. 7 is a side view of a preferred embodiment of the repaving system of the present invention.

FIG. 8 is a flow chart of the steps of the method of the present invention.

### DETAILED DESCRIPTION OF THE INVENTION

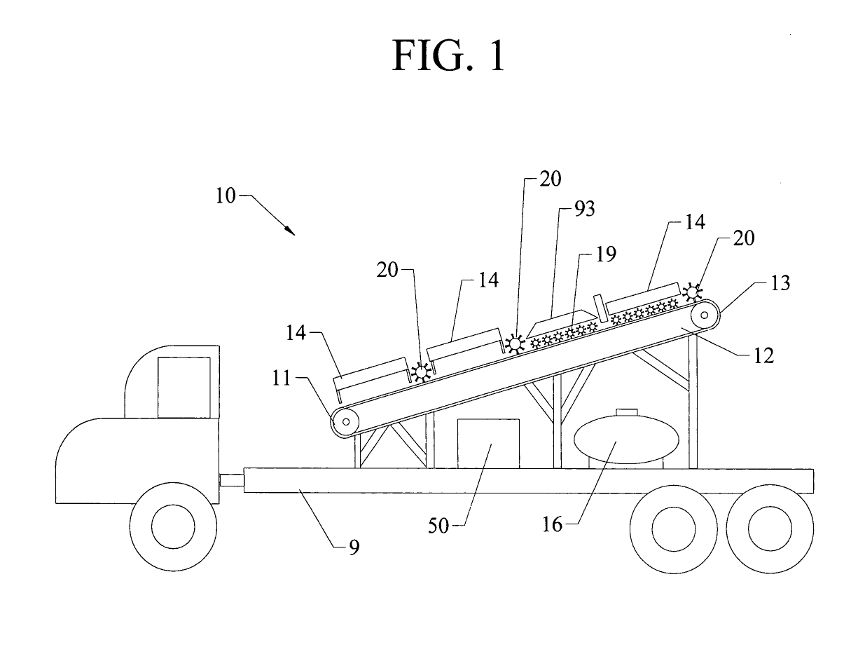

Referring to FIG. 1, a side view of one embodiment of the heating system 10 of the present invention is provided. Heating system 10 includes trailer 9, conveyor belt 12 with first and terminal ends 11, 13 respectively, infrared chambers 14, source of fuel 16, large mixers 20, small mixers 19, heat reflector 93, temperature sensor 21, and source of power 50.

Trailer 9 is preferably a 50′ trailer, but may be smaller or larger depending on the size of the conveyor belt 12 and number of infrared chambers 14 included in the heating system 10 being utilized. In addition, for heating systems 10 that include many infrared chambers 14, more than one trailer 9 may be utilized and aligned with one another.

FIG. 1 depicts a heating system 10 including a conveyor belt 12 long enough so that there is space for four infrared chambers 14 above it. It is understand that there may be fewer or greater infrared chambers 14 in other embodiments of heating system 10. Further, although five small mixers 19 each are depicted under heat reflector 93 and the infrared chamber 14 closest to the terminal end 13 of conveyor belt 12, it is understood that there may be fewer or more small mixers 19 included in the area of the conveyor belt 12 under heat reflector 93 and the last infrared chamber 14, so that there may be no small mixers 19, and there may be small mixers 19 covering the area. These features are discussed in greater detail below.

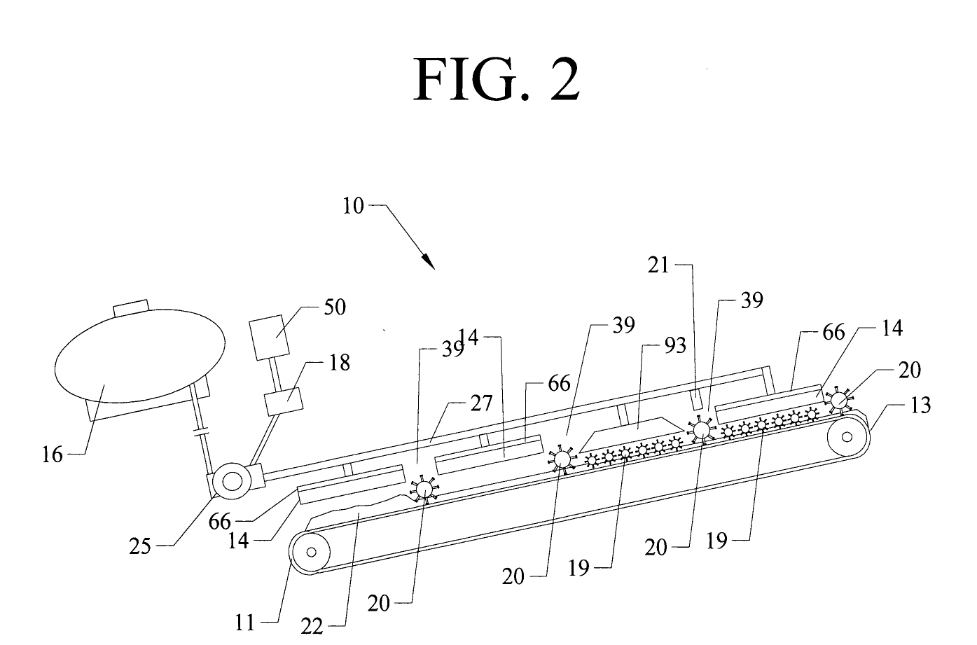

Referring now to FIG. 2, a side view schematic of one embodiment of the heating system 10 of the present invention is shown without trailer 9. This exclusion is for clarity and to better describe the other elements of heating system 10, and should suggest neither that heating system 10 does not include trailer 9 nor that trailer 9 is an optional feature of heating system 10.

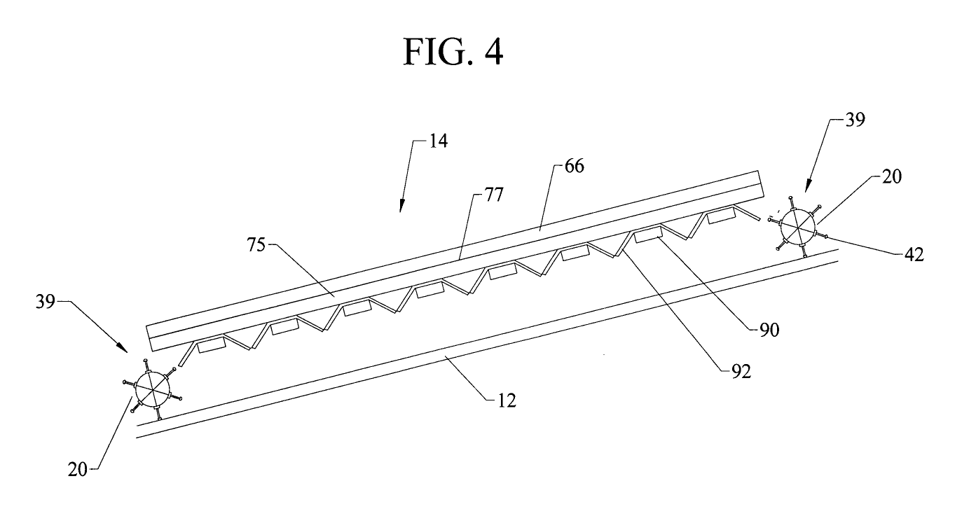

The heating system 10 includes a conveyor belt 12 in communication with a source (not shown) of the aggregate material 22. The conveyor belt 12 has a first end 11, where aggregate material 22 is first deposited onto the conveyor belt 12, and a terminal end 13, where the dried and heated aggregate material 22 leaves the conveyor belt 12. The conveyer belt 12 preferably takes the form of conveyor belts currently used to transport aggregate material in conventional HMA and WMA manufacturing processes. The belt may be manufactured of a non-combustible material, such as steel, but is preferably a composition belt manufactured of a rubberized material. Such a material is preferred due its gripping properties and price. The conveyor belt 12 is adapted to convey the aggregate material 22 at a predetermined rate from the source to another location, such as a rotating drying drum (not shown). The conveyor belt 12 is preferably in an inclined position, up to a four to one incline, to facilitate the chimney like aspects of the aluminum top portion 77 (shown in FIG. 4) of each infrared chamber 14. However, the conveyor belt 12 may also be substantially horizontal. As discussed below, the conveyor belt 12 may include controls to allow the rate of the conveyor belt 12 to be varied based upon the moisture content or temperature of the aggregate material 22.

The heating system 10 also includes at least one infrared chamber 14. In the embodiment of FIG. 2, the distance over conveyor belt 12 is covered by three infrared chambers and one heat reflector 93. It is preferable that the penultimate structure above the conveyor belt 12 toward its terminal end 13 be heat reflector 93, and the ultimate structure be an infrared chamber 14 as shown, but it is understood that all spaces may be occupied by infrared chambers 14 and that more than one heat reflector 93 may be positioned over the conveyor belt 12 and may be so positioned at any position, not exclusive of the penultimate position. Moreover, in other embodiments of the heating system 10, greater or fewer infrared chambers 14 may be utilized. The preferred embodiment, however, includes seven infrared chamber 14 and one heat reflector 93 in the penultimate position. The infrared chambers 14 and heat reflector 93 are preferably 8′×3′. Heat reflector 93 is made of a heat reflective material, preferably aluminum. The infrared chambers 14 and heat reflector 93 are mounted in substantially parallel relation to the conveyor belt 12 and are disposed at a distance above the conveyor belt 12, preferably four inches, sufficient to allow infrared radiation to penetrate into the aggregate material 22. The distance between the infrared chambers 14 or heat reflector 93 and the conveyor belt 12 may be adjusted as a control for the amount of heat applied to the aggregate material 22. The infrared chambers 14 are dimensioned to extend over the entire width of the conveyor belt 12 and are manufactured in different sizes to accommodate different widths of conveyor belts 12; typically thirty, thirty-six, sixty and seventy-two inches. As shown in FIG. 4, in instances where sixty or seventy-two inch wide conveyor belts 12 are utilized, two infrared chambers 14 or heat reflectors 93 may be mounted in side by side relation to one another to cover the width of the conveyor belt 12.

The infrared chambers 14 are in communication with a source of fuel 16, preferably propane but natural gas may also be used. When natural gas is used, the gas must be introduced to the infrared chambers 14 at a higher pressure than when propane is used, but no modifications to the hardware of the system are necessary to use natural gas instead of propane. In the embodiment of FIG. 2, fuel 16 is forced into the infrared chambers 14 by a blower motor 25. The blower motor 25 mixes fuel 16 with air and delivers the mixture, under pressure, through the manifold 27 to igniter assemblies 66. The preferred embodiment utilizes multiple, individual igniter assemblies 66, which are each in communication with a single infrared chamber 14 and are independently controlled by the control box 18. Each igniter assembly 66 is itself in communication with the source of fuel 16 through the manifold 27, and includes two igniter rods (one of which is shown from the side), two sparker transformers with mounting plates, one flame sensor, a main gas valve, and a pressure switch (the rest of which are not shown). The rods are in communication with the infrared converters 90 of the infrared chambers 14, so that the ignited fuel may travel into the converters 90, and provide uniform heating. Having individual igniter assemblies 90 for each infrared chamber 14, rather than a single igniter used to ignite the fuel 16 within each of the chambers 14, is preferable as it allows individual infrared chambers 14 to be turned off. This provides greater control over the heating of the system, which is particularly important when RAP is being used as the aggregate.

The preferred blower motor 25 also includes a shut off valve (not shown) to shut off the flow of fuel 16 to the infrared chambers 14. A control box 18, which is in electrical communication with the blower motor 25 and a source of power 50, preferably controls the operation of the blower motor 25. Source of power 50 is preferably a generator as shown in FIG. 1, and is capable of powering the control box 18 and the mechanical elements of system 10. As described with reference to other embodiments, the control box 18 may also include other controls, such as ignition controls, speed controls for the conveyor belt 12 and mixers 20, 19, and elevation controls for the infrared chambers 14. The use of a blower motor 25 and control box 18 is preferred as it allows the infrared chamber 14 to consistently produce a greater amount of heat than may be produced by relying upon the pressure from the source of fuel 16 alone. However, in other embodiments, both the blower motor 25 and control box 18 are eliminated and the flow of fuel 16 to the infrared chambers 14 is controlled via a manually operated valve (not shown), which opens to allow fuel 16 to flow solely via pressurization from the fuel source and is closed to shut off flow completely.

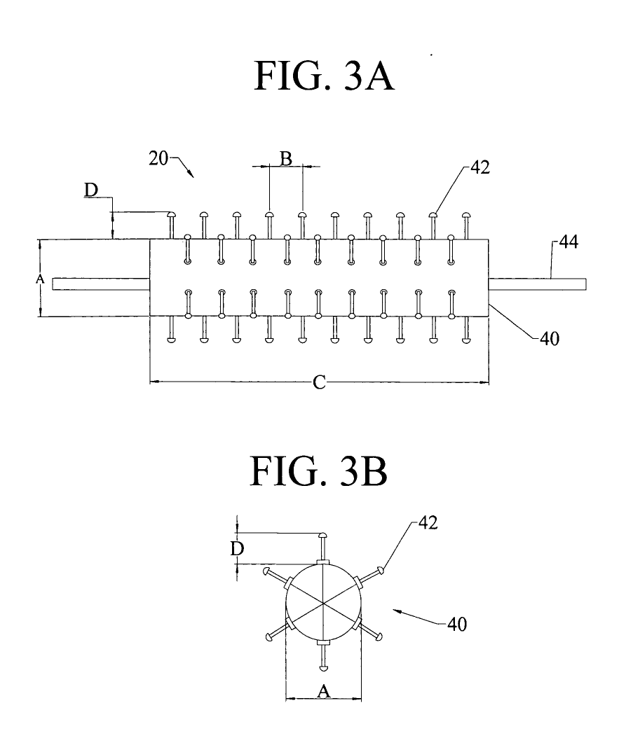

At least one large mixer 20 is disposed between the infrared chambers 14 and the conveyor belt 12. The large mixer 20 is dimensioned and disposed relative to the conveyor belt 12 so as to mix the aggregate material 22 during pre-drying. The large mixer 20 contacts the aggregate material 22 and mixes the hot top layer with the cool lower layer to form a substantially homogenous mixture. The infrared chambers 14 and heat reflector 93 are disposed so as to form a gap 39 therebetween. A large mixer 20 is preferably disposed within each gap 39. A final large mixer 20 is disposed at the terminal end 13 of conveyor belt 12. The large mixer 20 is described in more detail with reference to FIGS. 3A and 3B.

Small mixers 19 are preferably included under the heat reflector 93 and infrared chamber 14 closest to the terminal end 13 of the conveyor belt 13. The small mixers 19 are preferably similar in both shape and function to the large mixers 20 discussed above and in more detail with reference to FIGS. 3A and 3B, but smaller in diameter and the length of the protruding bolts. The small mixers 19 may be directly adjacent to one another, rather than being spaced between infrared chambers 14 as are the large mixers 20. The speed at which the small mixers 19 rotate is also preferably controllable, and is preferably faster than the speed of rotation of the large mixers 20. The small mixers 19 protect against ignition of the asphalt within the RAP by ensuring even distribution of heat throughout the aggregate when the aggregate is at its hottest on the conveyor belt 12. In general, at the point in the drying/heating process when the aggregate material 22 reaches the small mixers 19, if an infrared chamber 14 is over the small mixers 19, the distance between the infrared chamber 14 and the conveyor belt 12 will be increased as a heat control measure. This elevation increase may be in response to a temperature reading from temperature sensor 21 preferably disposed between heat reflector 93 and the infrared chamber closest to the terminal end 13 of the conveyor belt 12. Temperature sensor 21 is may be any temperature or heat measuring device that can withstand the heat at the end of the conveyor belt 12, such as a thermometer or thermal gun.

In operation, the conveyor belt 12 conveys the aggregate material 22 from its source and under the infrared chambers 14 at a predetermined rate. The fuel 16 flows to the infrared chambers 14, which burn the fuel 16 causing the infrared chambers 14 to emit infrared radiation therefrom. The infrared radiation contacts the top surface of the aggregate material 22 that is conveyed on the conveyor belt 12 and acts to heat the top portion of the aggregate material proximate to the infrared chambers 14. Large mixers 20 then mix the aggregate material 22 such that the heated and unheated layers of aggregate material 22 are mixed together, allowing the unheated aggregate material 22 proximate to the conveyor belt 12 to rise to the top surface proximate to the infrared chamber 14. The infrared radiation from the infrared chamber 14 then heats the mixed aggregate material 22 to effectively pre-heat and pre-dry the aggregate material 22.

Referring now to FIGS. 3A and 3B, the preferred large mixer 20 is shown. The preferred large mixer 20 is a rotary mixer including a bolted roller 40 with 5″ diameter (diameter A) disposed around a pipe 44. The roller 40 includes six evenly spaced bolts 42, as shown in FIG. 3B, protruding from cross sections spaced 2″ apart down the length of the roller 40, with every other set of bolts 42 being offset from the sets of bolts 42 on either side of it, so that sets of bolts 42 that are not offset from one another are 4″ (distance B) apart. Each bolt 42 is preferably 3″ (height D) long. The preferred roller 40 is 40″ wide (width C). This is wide enough so as to cross the width of the preferred 3′×8′ infrared chamber 14 under and/or between the infrared chambers 14. When wide conveyor belts 12 are used, two or more of the large mixers 20 may be used side by side, as depicted in FIG. 4. In the preferred embodiment, the large mixers 20 are individually controlled as to how fast they rotate, and thus mix the aggregate material 22.

Referring now to FIG. 4, a side view of the preferred infrared chamber 14 is shown. The infrared chamber 14 shown in FIG. 4 is an infrared chamber 14 toward the first end 11 of the conveyor belt 12, in that the mixers depicted at either end of infrared chamber 14 are large mixers 20, and not small mixers 19, as may be present under an infrared chamber 14 at the terminal end 13 of the conveyor belt 12. The preferred infrared chamber 14 includes eight infrared energy converters 90. These infrared energy converters 90 are preferably of the type manufactured by Ray-Tech Infrared Corporation of Charlestown, N.H., and described in connection with the inventor's U.S. Pat. No. 6,227,762. An angled reflector 92 is mounted about each infrared converter 90 such that the infrared energy generated by each converter is concentrated downward toward the conveyor belt 12. Angled reflector 92 is manufactured of a heat reflective material, preferably aluminum, and includes a body and a pair of wings extending downward from the body. Angled reflector 92 is similar to heat reflector 93, but heat reflector 93 is commensurate with an infrared chamber 14, while angled reflector 92 is approximately an eighth of the size of an infrared chamber 14, as each infrared chamber 14 preferably includes eight angled reflectors 92 for each of the eight infrared energy converters 90. Each infrared energy converter 90 is arranged in approximately perpendicular orientation from the direction of travel of the conveyor belt 12 and each infrared energy converter 90 is spaced slightly apart from an adjacent infrared energy converter 90 in order to allow a large mixer 20 to be disposed therebetween. In the preferred embodiment, the large mixers 20 are disposed approximately 12″ apart from each other to allow for substantially continuous mixing of the aggregate material 22. However, larger or smaller spacing may be utilized to achieve similar results. The preferred infrared chamber 14 includes a frame 75 and a top portion 77. Top portion 77 is preferably made of solid aluminum. Moisture escapes out of the upper end of the infrared chambers 14 in the gaps 39 between the infrared chambers 14 where the large mixers 20 are placed. The conveyor belt 12 is preferably inclined so as to act as a chimney to facilitate this moisture escape. FIG. 4 also shows a side view of the preferred igniter assembly 66, which shows one igniter rod from this view.

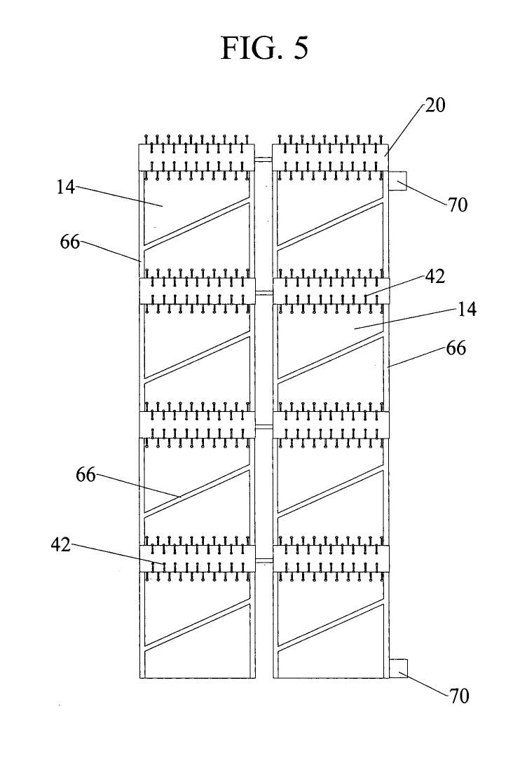

Referring now to FIG. 5, a top down view of another embodiment of the heating system 10 is shown. This embodiment shows an arrangement of eight infrared chambers 14 disposed in side by side relation and is used with wide conveyor belts 12, such as those that are 60″ or 72″ wide. In such instances, the infrared chambers may be mounted in side by side relation to one another to cover the width of the conveyor belt 12. Large mixers 20 with their bolts 42 as teeth are visible between the infrared chambers 14. The preferred igniter assembly 66 is also visible above the infrared chamber 14, including igniter rods on either side of the infrared chamber 14 and a tube stretching between them through which gas may pass between them, the tube preferably being placed diagonally across the middle of the infrared chamber 14. The igniter assembly 66 is adapted to ignite the fuel 16 within each infrared chamber 14 so that it may be burned and turned into infrared radiation.

The embodiment of FIG. 5 includes one hygrometer 70 for determining the moisture content of the aggregate material 22 at least at the start of the pre-heating process and another hygrometer 70 at the end of the pre-heating process. In such embodiments, the hygrometers 70 are in communication with a conveyor control (not shown), which slows the conveyor belt 12 or speeds up the conveyor belt 12 based upon the amount of moisture within the aggregate material 22. Thus use of such a control is preferred when the system is used in connection with WMA manufacturing as it allows for careful control of the amount of moisture while maximizing the speed of the process in instances where there are minimal amounts of moisture within the aggregate. In other embodiments, the hygrometer 70 is replaced by a thermometer, which measures the temperature of the aggregate material 22 and controls the speed of the conveyer belt 12 accordingly. In particular, as shown in FIGS. 1 and 2, temperature sensor 21 is employed between heat reflector 93 and infrared chamber 14 to assess the temperature of the aggregate material 22 at that point. The area of the conveyor belt 12 closest to the terminal end 13 is where the aggregate material 22 will be at its hottest after having passed under a plurality of infrared chambers 14. When the aggregate material 22 is largely or entirely made up of RAP, it is particularly important that the temperature of the material be monitored and controlled to avoid ignition of the asphalt in the RAP. If temperature sensor 21 were to read a temperature at which there is a danger of ignition, then the final infrared chamber 14 could be elevated farther away from the conveyor belt 14, or shut off completely by turning off the dedicated igniter assembly 66 for that infrared chamber 14.

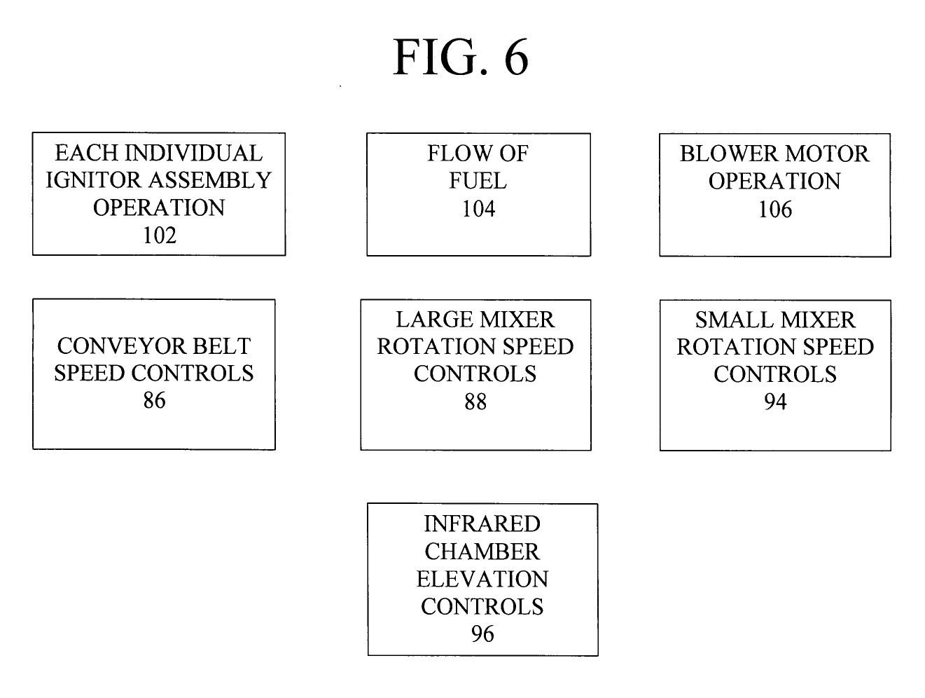

Referring now to FIG. 6, a block diagram showing the functions of the preferred control box 18 are provided. These functions include the operation of each individual igniter assembly 102, the flow of fuel 104 from the source to the infrared chambers, blower motor operation 106, conveyor belt speed control 86, large mixer rotation speed controls 88, small mixer rotation speed controls 94, and infrared chamber elevation controls 96.

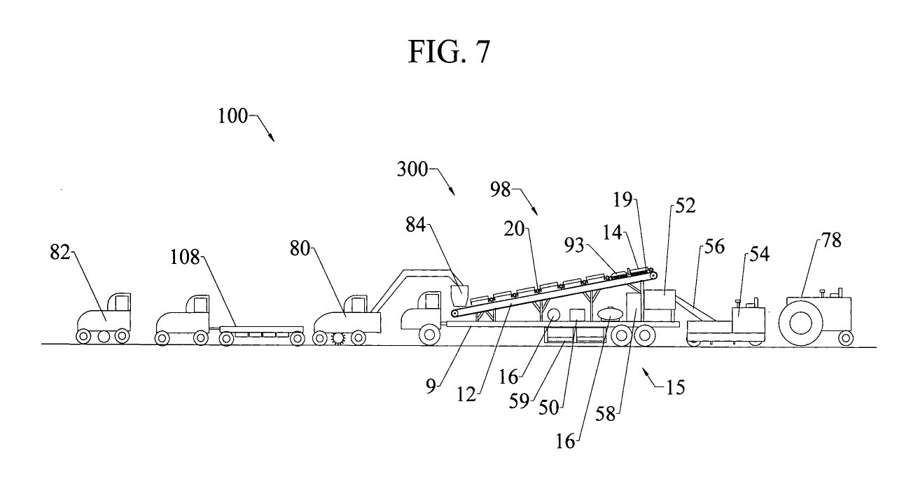

The present invention also includes an asphalt producing system 300 and a system 100 for continuously repaving a roadway. FIG. 7 is a side view of the preferred asphalt producing system 300 and repaving system 100. Asphalt producing system 300 includes a drying apparatus 98 and an asphalt producing module 15. Repaving system 100 preferably includes a cleaning unit 82, a joint heater 108, a grinder 80, a hopper 84, a drying apparatus 98, an asphalt producing module 15, at least one ground infrared heater 59, a paver 54, and a roller 78.

Drying apparatus 98 is as described above in the heating system 10, including conveyor belt 12, infrared chambers 14, heat reflector 93, source of fuel 16, source of power 50, and mixers 20, 19 mounted on trailer 9. Asphalt producing module 15 includes pugmill 52 and additive receptacle 58. Pugmill 52 is preferably portable, such as one of the portable pugmills sold by Pugmill Systems, Inc of Columbia, Tenn. In some embodiments, pugmill 52 may be substituted for a drum mill. Additive receptacle 58 may contain heated liquid asphalt for HMA production or the requisite additives for WMA production. Heated and dried aggregate material 22 is introduced to pugmill 52 from the terminal end 13 of conveyor belt 12, as are additives for either HMA or WMA from additive receptacle 54. The additive addition is automated. The same asphalt producing module 15 may be used for either WMA or HMA. Asphalt producing module 15 then produces new asphalt that may immediately be laid down and compacted to form new pavement.

Cleaning unit 82 is preferable in repaving system 100 particularly for partial repaves of center lines and widened roads that often have cracks with dirt in them. Cleaning unit 82 is a vehicle that drives ahead of the rest of the repaving system 100 and vacuums up such dirt.

Joint heater 108 follows cleaning unit 82. Joint heater 108 preheats the pavement to be ripped up. This softens the material so that the grinding and milling process will be accelerated. It also limits fracturing of stone in the material. Joint heater 84 includes a tractor pulling at least one trailer with infrared units attached to its underside so as to heat the ground beneath the trailer. For the sake of space, the joint heater 108 depicted in FIG. 6 includes only trailer, but it is understood that more trailers with infrared units may be attached to the trailer. Each trailer is preferably approximately 20′ long. The preferred repaving system 100 includes 2-3 trailers in the joint heater 108, but more or less may be used in other embodiments.

Grinder 80 rips up roadway and grinds it into small pieces. After the roadway is sufficiently ground up into aggregate material 22, it is provided to hopper 84. Hopper 84 levels out the flow of aggregate material 22 from grinder 80 so that it provides an even layer of aggregate material 22 to the conveyor belt 12 of drying apparatus 98. In some embodiments, hopper 84 includes a sensor and storage for additional aggregate material to add to the aggregate material 22 provided by grinder 80 when hopper 84 senses that there is not enough material to meet a desired production rate for the repaving system 100.

Aggregate material 22 is heated and dried as it moves through drying apparatus 98 as described above. The dried, heated aggregate material 22 is deposited into asphalt producing module 15 from the terminal end 13 of conveyor belt 12. WMA additives or heated liquid asphalt for HMA is added to the aggregate material 22 in asphalt producing module 15 as described above.

Repaving system 100 also preferably includes at least one ground infrared heater 59. Ground infrared heater 59 is affixed to the bottom of trailer 9 or another trailer used in repaving system 100 such that it emits heat onto the area of road that has been ripped up by grinder 80. Heating the ground to be repaved allows for a better thermal bond between the ground and the asphalt to be replaced upon the ground. The ground infrared heater 59 is dimensioned to cover a substantial portion of the bottom of trailer 9, preferably in dimensions of 8′×3′. Although only two ground heat reflectors 59 are depicted in FIG. 6, it is understood that a greater or lesser number of ground heat reflectors 59 may be included in repaving system 100.

The newly made asphalt is deposited into paver 54 by asphalt producing module conveyor belt 56. Paver 54 is any paver commonly used in the art capable of laying down asphalt to form newly paved road that is dimensioned so as to work in repaving system 100. Repaving system 100 also preferably includes roller 78, which follows behind the other vehicles in repaving system 100 and compacts the asphalt just laid down by paver 54.

FIG. 6 shows but one configuration of repaving system 100. It will be understood by one of ordinary skill in the art that fewer or more vehicles may hold the required elements of repaving system 100. Cleaning unit 82 may be omitted in some scenarios. Drying apparatus 98 and asphalt producing module 15 may be disposed on separate vehicles. More or fewer infrared chambers 14 may be included. More or fewer ground heat reflectors 59 may be included. These are a few examples of how repaving system 100 may differ from the depiction in FIG. 7, while maintaining its required elements and functionality. In all embodiments, the required elements are on trailers, or are incorporated into some type of vehicle that may be moved and rearranged so that repaving system 100 can be set up anywhere, very simply and quickly.

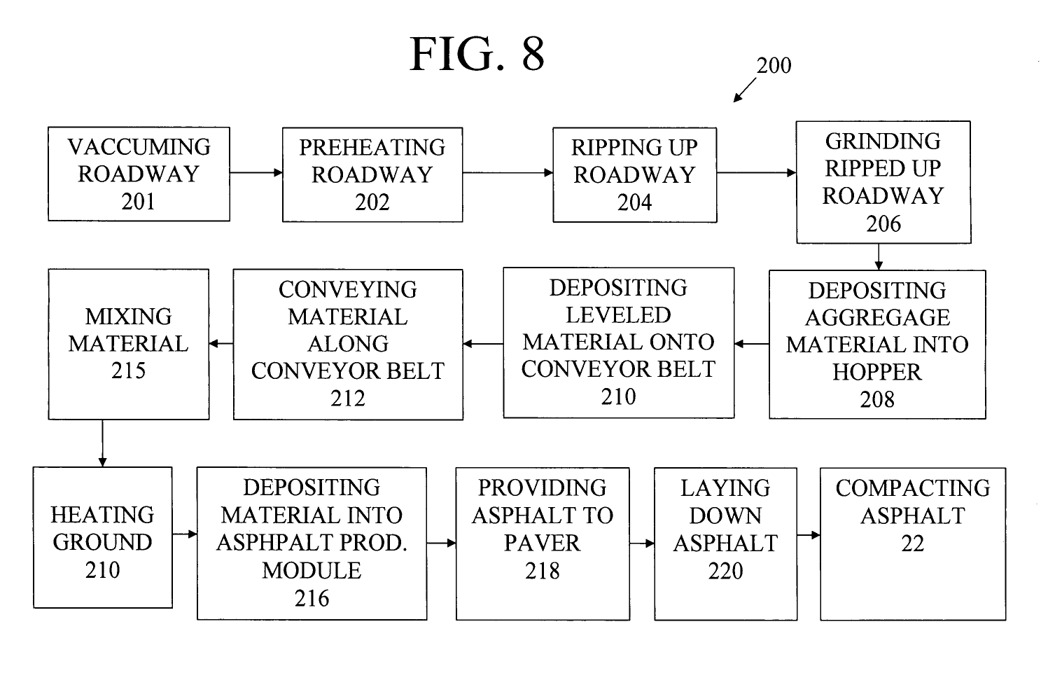

FIG. 8 is a flow chart showing the steps of method 200 of the present invention for continuously repaving a roadway. Method 200 mirrors the operation of repaving system 100 as described above and preferably includes the steps of: vacuuming the roadway to be ripped up 201; pre-heating the roadway to be ripped up 202; ripping up the roadway to be repaved 204; grinding the cleaned, ripped up roadway into aggregate material 206; depositing the aggregate material from the grinder to a hopper 208; depositing the aggregate material from the hopper to a conveyor belt 210; conveying the aggregate material along the conveyor belt under heating elements 212; mixing the aggregate material as it is conveyed along the conveyor belt 214; heating the ground to be repaved 215; depositing the aggregate material into an asphalt producing module 216; providing the asphalt product to a paver 218; laying down the asphalt product on the road that was just ripped up 220; and compacting the asphalt 222.

Although the present invention has been described in considerable detail with reference to certain preferred versions thereof, other versions would be readily apparent to those of ordinary skill in the art. Further, although the heating system was developed for use in connection with aggregates used as paving materials, it is readily adapted for use with aggregates used for other purposes, such as livestock feed, or the like. Therefore, the spirit and scope of the appended claims should not be limited to the description of the preferred versions contained herein.

We claim:

1. A portable system for heating an aggregate material, said system comprising:
a trailer sized and dimensioned to transport a conveyor belt, at least one infrared chamber, a source of fuel, and at least one first mixer, wherein each of said conveyor belt, at least one infrared chamber, source of fuel, and at least one mixer is disposed upon said trailer, wherein:
said conveyor belt is in communication with a source of the aggregate material, wherein said conveyor belt is adapted to convey the aggregate material at a predetermined rate;
said at least one infrared chamber is disposed in substantially parallel relation to said conveyor belt at a distance sufficient to allow infrared heating of the aggregate material;
said source of fuel is in communication with said infrared chamber;
said at least one first mixer is dimensioned and disposed relative to said conveyor belt so as to mix the aggregate material during heating;
wherein said conveyor belt conveys the aggregate material under said infrared chamber, fuel from said source of fuel flows to said at least one infrared chamber, said infrared chamber burns said fuel causing said infrared chamber to emit infrared radiation therefrom, the infrared radiation heats a portion of the aggregate material proximate to said infrared chamber, said at least one mixer mixes the aggregate material such that heated and unheated aggregate material are mixed together, and the infrared radiation heats the mixed aggregate material to effectively heat and dry the aggregate material.

2. The system as claimed in claim 1, wherein said at least one infrared chamber comprises an elevation unit adapted to adjust the distance between said at least one infrared chamber and said conveyor belt.

3. The system as claimed in claim 1 further comprising an igniter assembly dedicated to said at least one infrared chamber and adapted to ignite fuel from said source of fuel within said at least one infrared chamber and to be powered on and off at will.

4. The system as claimed in claim 1 further comprising at least one thermometer disposed so as to detect a temperature of the aggregate material.

5. The system as claimed in claim 1 further comprising at least one heat reflector disposed in substantially parallel relation to said conveyor belt at a distance at which heat emanating from the aggregate material is reflected back onto the aggregate material.

6. The system as claimed in claim 1, wherein said conveyor belt is inclined up to a four to one incline.

7. The system as claimed in claim 1, wherein said at least one infrared chamber further comprises a top portion made of solid aluminum.

8. The system as claimed in claim 1, wherein said at least one first mixer is a first rotary mixer comprising a first roller disposed about a first pipe and first bolts protruding from said first roller at evenly spaced intervals, wherein said first rotary mixer is adapted to rotate about said first pipe.

9. The system as claimed in claim 8, wherein said first roller is 5 inches in diameter and said first bolts are 3 inches in length.

10. The system as claimed in claim 9 comprising at least two infrared chambers, wherein said at least one first rotary mixer is disposed in a space between said at least two infrared chambers.

11. The system as claimed in claim 10 further comprising at least one second mixer disposed between said at least two infrared chambers and said conveyor belt.

12. The system as claimed in claim 11, wherein said at least one second mixer is a second rotary mixer comprising a second roller disposed about a second pipe and second bolts protruding from said second roller at evenly spaced intervals, wherein said second rotary mixer is adapted to rotate about said second pipe.

13. The system as claimed in claim 12, wherein said second roller is less than five inches in diameter and said second bolts are less than three inches in length.

14. The system as claimed in claim 12, wherein each infrared chamber comprises a plurality of infrared energy converters, wherein said at least one second rotary mixer comprises a plurality of second rotary mixers, and wherein said plurality of second rotary mixers are disposed between adjacent infrared converters.

15. The system as claimed in claim 1 further comprising at least one hygrometer disposed so as to detect an amount of moisture within the aggregate material and at least one conveyor belt control; wherein said at least one hygrometer is in electrical communication with said conveyor belt control and wherein said conveyor belt control is adapted to accept a signal from said hygrometer and to control a speed of said conveyor belt based upon said signal from said hygrometer.

16. The system as claimed in claim 8 further comprising a first mixer control adapted to control the speed at which said first pipe rotates and wherein said at least one first mixer is in electrical communication with said first mixer control.

17. The system as claimed in claim 4 further comprising at least one conveyor belt control; wherein said at least one thermometer is in electrical communication with said conveyor belt control and wherein said conveyor belt control is adapted to accept a signal from said thermometer and to control a speed of said conveyor belt based upon said signal from said thermometer.

18. The system as claimed in claim 2 further comprising a thermometer disposed so as to detect a temperature of the aggregate material, wherein said thermometer is in electrical communication with said elevation unit, and wherein said elevation unit is adapted to accept a signal from said thermometer and to adjust the elevation of said at least on infrared chamber based upon said signal from said thermometer.

19. A portable system for producing asphalt comprising:
a trailer sized and dimensioned to transport a conveyor belt, at least one infrared chamber, at least one thermometer, a source of fuel, at least one rotary mixer, and an asphalt producing module, wherein each of said conveyor belt, at least one infrared chamber, source of fuel, at least one mixer, and asphalt producing module is disposed upon said trailer, wherein:
said conveyor belt is in communication with a source of the aggregate material, wherein said conveyor belt is adapted to convey the aggregate material at a predetermined rate, and wherein said conveyor belt comprises a first end and a terminal end;
said at least one infrared chamber is disposed in substantially parallel relation to said conveyor belt at a distance sufficient to allow infrared heating of the aggregate material and comprises:
an igniter assembly dedicated to said at least one infrared chamber and adapted to ignite fuel from said source of fuel within said at least one infrared chamber and to be powered on and off at will; and
an elevation unit adapted to adjust the distance between said at least one infrared chamber and said conveyor belt;
said at least one thermometer is disposed so as to detect a temperature of the aggregate material;
said source of fuel is in communication with said infrared chamber;
said at least one rotary mixer is dimensioned and disposed relative to said conveyor belt so as to mix the aggregate material during heating and comprises a roller disposed about a pipe and bolts protruding from said roller at evenly spaced intervals, wherein said at least one rotary mixer is adapted to rotate about said pipe;
said asphalt producing module is disposed proximate to said terminal end of said conveyor belt such that said conveyor belt deposits the aggregate material into said asphalt producing module, wherein said asphalt producing module is adapted to mix the aggregate material with at least one additive;
wherein said conveyor belt conveys the aggregate material under said at least one infrared chamber, fuel from said source of fuel flows to said at least one infrared chamber, said infrared chamber burns said fuel causing said infrared chamber to emit infrared radiation therefrom, the infrared radiation heats a portion of the aggregate material proximate to said infrared chamber, said at least one rotary mixer mixes the aggregate material such that heated and unheated aggregate material are mixed together, the infrared radiation heats the mixed aggregate material to effectively heat and dry the aggregate material, said conveyor belt deposits the heated and dried aggregate material into said asphalt producing module, and said asphalt producing module produces asphalt.

20. The system as claimed in claim 19, wherein said asphalt producing module is a pugmill.

21. The system as claimed in claim 19, wherein said at least one additive mixed by said asphalt producing module is liquid asphalt.

22. A portable system for continuously repaving a roadway comprising:
a grinder, wherein said grinder is adapted to rip up pavement and grind the pavement into small pieces of aggregate material;
a hopper disposed adjacent to said grinder such that said grinder deposits the aggregate material into said hopper, wherein said hopper is adapted to level out the aggregate material and to control the flow of aggregate material deposited from said grinder;
a drying apparatus comprising:
a conveyor belt, comprising a first end and a terminal end, disposed adjacent to said hopper such that said hopper deposits the aggregate material onto said conveyor belt at said first end in a layer that is substantially consistent in thickness and mass, wherein said conveyor belt is adapted to convey the aggregate material at a predetermined rate;
at least one infrared chamber disposed in substantially parallel relation to said conveyor belt at a distance sufficient to allow infrared heating of the aggregate material and comprises:
an igniter assembly dedicated to said at least one infrared chamber and adapted to ignite fuel from said source of fuel within said at least one infrared chamber and to be powered on and off at will; and
an elevation unit adapted to adjust the distance between said at least one infrared chamber and said conveyor belt;
at least one thermometer disposed so as to detect a temperature of the aggregate material;
a source of fuel in communication with said infrared chamber;
at least one rotary mixer dimensioned and disposed relative to said conveyor belt so as to mix the aggregate material during heating and comprising a roller disposed about a pipe and bolts protruding from said roller at evenly spaced intervals, wherein said at least one rotary mixer is adapted to rotate about said pipe;
wherein said conveyor belt conveys the aggregate material under said at least one infrared chamber, fuel from said source of fuel flows to said at least one infrared chamber, said infrared chamber burns the fuel causing said at least one infrared chamber to emit infrared radiation therefrom, the infrared radiation heats a portion of the aggregate material proximate to said infrared chamber, said at least one rotary mixer mixes the aggregate material such that heated and unheated aggregate material are mixed together, and the infrared radiation heats the mixed aggregate material to effectively heat and dry the aggregate material;
an asphalt producing module disposed proximate to said terminal end of said conveyor belt such that said conveyor belt deposits the aggregate material into said asphalt producing module, wherein said asphalt producing module is adapted to mix the aggregate material with at least one additive; and
a paver, wherein:
said paver is disposed proximate to said asphalt producing module;
said asphalt producing module is further adapted to deposit the asphalt product into said paver; and
said paver is adapted to lay down the asphalt product.

23. The system as claimed in claim 22 further comprising a roller to compact the asphalt product laid down by said paver.

24. The system as claimed in claim 22 further comprising a cleaning unit adapted to vacuum dirt from pavement to be ripped up and repaved.

25. The system as claimed in claim 19 further comprising a joint heater adapted to pre-heat pavement to be ripped up and repaved.

26. The system as claimed in claim 19 further comprising a trailer and at least one ground infrared heater affixed to a bottom of said trailer such that said ground infrared heater emits heat onto an area of ground that has been ripped up by said grinder.

27. A method for continuously repaving a road comprising the steps of:
vacuuming pavement to be ripped up;
pre-heating pavement to be ripped up;
ripping up the pavement to be repaved;
grinding the cleaned, ripped up roadway into aggregate material;
depositing the aggregate material from a grinder to a hopper;
depositing the aggregate material from the hopper to a conveyor belt;
conveying the aggregate material along the conveyor belt under heating elements;
mixing the aggregate material as it is conveyed along the conveyor belt;
heating the ground to be repaved;
depositing the aggregate material into an asphalt producing module;
providing the asphalt product to a paver;
laying down the asphalt product on the road that was just ripped up; and
compacting the asphalt.
